(19) United States
(12) Patent Application Publication
(10) Pub. No.: US 2026/0132743 A1
(43) Pub. Date: May 14, 2026

(54) Actuation Bypass Regulator and Selector Valve for a Variable Displacement Pump

(71) Applicant: Hamilton Sundstrand Corporation, Charlotte, NC (US)

(72) Inventors: Sachin RAMPRASHAD, West Hartford, CT (US); Ryan Prescott SUSCA, Windsor, CT (US)

(21) Appl. No.: 18/933,307

(22) Filed: Oct. 31, 2024

(51) Int. Cl. F02C 7/232

(52) U.S. Cl. CPC F02C 7/232; F05D 2260/83

(57) ABSTRACT

Apparatus and associated methods relate to a fueldraulic valve configured to provide bypass regulation of fueldraulic power provided by a variable-displacement hydraulic pump and to simultaneously provide backup fueldraulic power for the variable displacement actuator pump. Bypass regulation is provided by moving a bilaterally moveable spool within a hydraulic cylinder from a first position so as to provide fluid conductivity between an actuation-supply port and a drain port. Backup fueldraulic power is provide by moving the bilaterally moveable spool further within a hydraulic cylinder from a first position so as to provide fluid conductivity between an actuation-supply port and an afterburner-supply port.

### BACKGROUND

Fuel is not only used for combustion in gas turbine engines but is also used as a hydraulic fluid for operating various engine system actuators. Such fuel-based hydraulic systems can be called fueldraulic systems. There are many advantages for using fuel as hydraulic fluid for operating the various engine system actuators. Fuel is readily available within gas turbine engines, as it is pumped to the combustion chambers thereof. Such fueldraulic systems are relatively small and local, residing in or near the gearbox of the gas turbine engine. Moreover, such localization of these fueldraulic systems obviates the need to run hydraulic lines the long distances between the airframe and the gas turbine engines.

Typically, these fueldraulic systems use fixed-displacement hydraulic pumps that are driven by the gearboxes of the gas turbine engines. Such fixed-displacement hydraulic pump a fixed-volume of fuel per unit of time. Therefore, fixed-displacement hydraulic pumps are sized so as to pump a volume of fuel per unit of time that is in excess of the greatest demand expected for operation of the engine system actuators. Any excess fuel volume that is pumped by such fixed-displacement hydraulic pumps is shunted away from (i.e., bypasses) the engine system actuators and is recirculated. Thus, high-volume recirculation of fuel occurs in such fueldraulic systems that use fixed-displacement hydraulic pumps. This pumping and recirculation of fuel causes heating of the fuel. The heated and recirculated fuel must be cooled to maintain it within a specified temperature band. If the temperature of the fuel is too low, viscosity of the fuel can be too great to permit proper atomization by fuel injectors. If the temperature of the fuel is too high, carbonization and coking of the fuel can result.

### SUMMARY

Some embodiments relate to a fueldraulic valve for a gas turbine engine configured to regulate actuation pressure and to select between an actuation pump and a backup pump. The fueldraulic valve includes a hydraulic cylinder and a bilaterally moveable spool. The hydraulic cylinder has a cylindrical wall extending between first and second ends. The cylindrical wall has a first radius over a first portion and a second radius larger than the first radius over a second portion. The cylindrical wall has a plurality of hydraulic ports therethrough including a pair of spool-controller ports in the second portion, and an actuator-supply port, a drain port, and an afterburner-supply port in the first portion. The bilaterally moveable spool is axially moveable between first and second positions within the hydraulic cylinder. The bilaterally moveable spool has a first sealing land with a first radius configured to provide a hydraulic seal with an interior surface of the cylindrical wall within the first portion and a second sealing land configured to provide a hydraulic seal with an interior surface of the cylindrical wall within the second portion. The bilaterally moveable spool is configured to provide fluid conductivity between the actuator-supply port and the drain port in response to a pressure differential between the pair of spool-controller ports exceeding a first threshold pressure. The bilaterally moveable spool is configured to provide fluid conductivity between the actuator-supply port and the afterburner-supply port in response to a pressure differential between the pair of spool-controller ports exceeding a second threshold pressure, which is greater than a first supply pressure.

Some embodiments relate to a fueldraulic system for a gas turbine engine. The fueldraulic system includes a variable-displacement fueldraulic actuator pump configured to provide fueldraulic actuator power to an actuator of the gas turbine engine. The fueldraulic system includes an afterburner fuel pump configured provide fueldraulic afterburner power thereby supplying fuel to an afterburner of the gas turbine engine. The fueldraulic system includes a fueldraulic valve configured to provide bypass regulation of the fueldraulic power and to shunt the fueldraulic afterburner power to the fueldraulic actuator power in response to a failure of the variable-displacement fueldraulic actuator pump. The fueldraulic valve includes a hydraulic cylinder and a bilaterally moveable spool. The hydraulic cylinder has a cylindrical wall extending between first and second ends. The cylindrical wall has a first radius over a first portion and a second radius larger than the first radius over a second portion. The cylindrical wall has a plurality of hydraulic ports therethrough including a pair of spool-controller ports in the second portion, and an actuator-supply port in fluid communication with the variable-displacement fueldraulic actuator pump, a drain port, and an afterburner-supply port in fluid communication with the afterburner fuel pump in the first portion. The bilaterally moveable spool is axially moveable between first and second positions within the hydraulic cylinder. The bilaterally moveable spool has a first scaling land with a first radius configured to provide a hydraulic seal with an interior surface of the cylindrical wall within the first portion and a second sealing land configured to provide a hydraulic seal with an interior surface of the cylindrical wall within the second portion. The bilaterally moveable spool is configured to provide fluid conductivity between the actuator-supply port and the drain port in response to a pressure differential between the pair of spool-controller ports exceeding a first threshold pressure. The bilaterally moveable spool is configured to provide fluid conductivity between the actuator-supply port and the afterburner-supply port in response to a pressure differential between the pair of spool-controller ports exceeding a second threshold pressure, which is greater than a first supply pressure.

### BRIEF DESCRIPTION OF THE DRAWINGS

FIG. 1 is a schematic view of an embodiment of a fueldraulic system for an afterburning gas turbine engine.

FIG. 2 is a schematic view of an embodiment of an actuation bypass regulator and selector valve (ABRSV).

FIG. 3 is a graph of a pressure/time relation for a fueldraulic system having an ABRSV to regulate bypass of an actuation system.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

Reduction in the volume of heated and recirculated fuel can be accomplished by replacing the fixed-displacement hydraulic pump of the fueldraulic system with a variable-displacement hydraulic pump. Such variable-displacement hydraulic pumps can be controlled to pump different volumes of fuel per unit of time, in response to different fuel-volume demands of the fueldraulic system at different times. A fueldraulic system controller can send command signals to the variable-displacement hydraulic pump to respond to changes in the demand for fuel volume. The response time of variable-displacement hydraulic pumps to such command signals, however, is not instantaneous. Some changes in fuel-volume demand are slow, and the variable-displacement hydraulic pump can acceptably respond (e.g., with changes in fuel pressure below a delta-pressure value) to such slow changes in fuel-volume demand. Other changes in fuel-volume demand are fast, and the variable-displacement hydraulic pump cannot respond before the pressure peaks or dips unacceptably. Such fast changes in fuel-volume demand can be caused by system actuators that are commanded to change position. For example, at the beginning of such a position change of a system actuator, the fuel-volume demand can suddenly increase, and at the end of the position change of the system actuator, the fuel-volume demand can suddenly decrease (e.g., the fuel-volume demand often returns to its value before actuation of the system actuator).

Bypass regulation of the system actuators, however, can be used to prevent changes in fuel pressures from becoming unacceptable (e.g., fuel-pressure changes can be maintained within the delta-pressure value of a target-pressure value). Bypass regulation can be achieved by commanding the variable-displacement hydraulic pump to pump more than the fuel-volume demand needed by the system actuators, and shunting away (i.e., bypassing) the excess fuel volume. An actuation bypass regulator can be used to quickly respond to such fast changes in fuel-volume demand. For example, when the fuel-volume demand suddenly increases, the actuation bypass regulator can respond by lessening the amount of fuel that is shunted away from the system actuators, thereby providing more fuel to the system actuators. Conversely, when the fuel-volume demand suddenly decreases, the actuation bypass regulator can respond by increasing the amount of fuel that is shunted away from the system actuators, thereby providing less fuel to the system actuators. The amount of fuel shunted and thereby recirculated is far less for fueldraulic systems that use variable-displacement hydraulic pumps than for those using fixed-displacement hydraulic pumps. This is because the volume of fuel that is shunted away from the system actuators need only be equal to or just greater than the volume needed for regulation.

Reduction in the volume of fuel that is heated and recirculated within the fueldraulic systems leads to a corresponding reduction in the components (e.g., number and/or size of components) necessary for cooling and recirculating the heated and recirculated fuel. Moreover, smaller fueldraulic systems, such as those realizable due to use of variable-displacement hydraulic pumps, can require lower power, which is provided by the gear box of the gas turbine engine. Because the pump(s) can have reduced pump horsepower, the size of the gears/bearings in the gearbox can be reduced as the amount of power transmitted from the engine tower shaft is reduced. Because of this component reduction and the reduced gear-box power, using variable-displacement hydraulic pumps reduces the weight of fueldraulic systems and gearbox for gas turbine engines, and improves the overall thrust-specific fuel consumption of jet turbine engines so equipped. Finally, because recirculated fuel is used as a washing flow for the actuator servo filter, some volume of recirculated fuel is desired.

Apparatus and associated methods relate to a fueldraulic valve configured to provide bypass regulation of fueldraulic power provided by a variable-displacement hydraulic pump and to simultaneously provide backup fueldraulic power for the variable displacement actuator pump. Bypass regulation is provided by moving a bilaterally moveable spool within a hydraulic cylinder from a first position so as to provide fluid conductivity between an actuation-supply port and a drain port. Backup fueldraulic power is provide by moving the bilaterally moveable spool further within a hydraulic cylinder from a first position so as to provide fluid conductivity between an actuation-supply port and an afterburner-supply port.

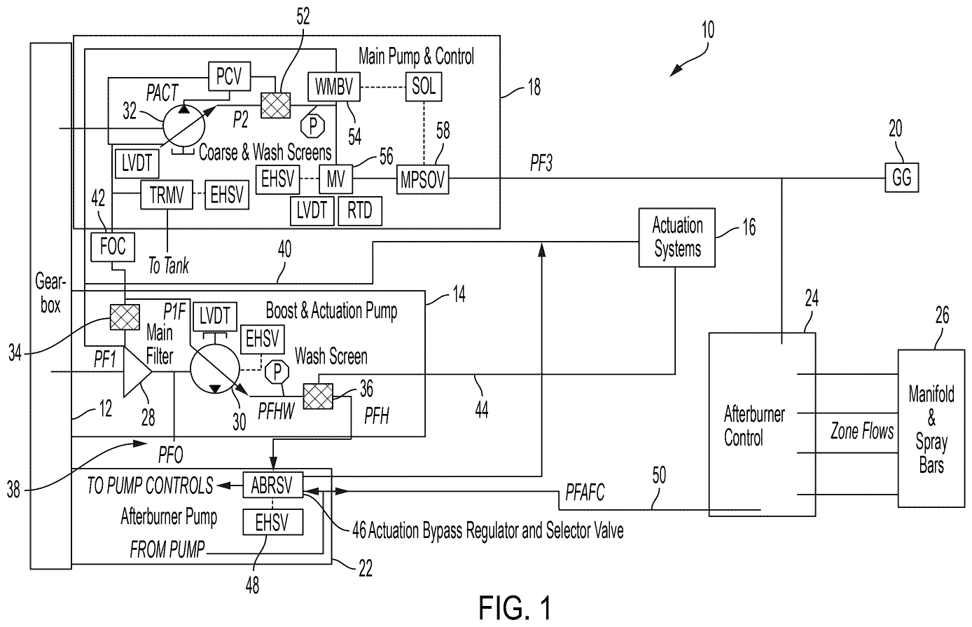

FIG. 1 is a schematic view of an embodiment of a fueldraulic system for an afterburning gas turbine engine. In FIG. 1, fueldraulic system 10 includes gearbox 12, actuation pump sub-subsystem (APS) 14, actuation systems 16, main pump and control sub-system (MPCS) 18, gas generator (GG) 20, afterburner sub-system 22, afterburner control 24, and afterburner manifold and spray bars 26. Gearbox 12 is coupled with an afterburning gas turbine engine and is configured to interface with APS 14, MPCS 18, and afterburner sub-system 22. Gearbox 12 provides mechanical power to mechanically powered devices, such as, for example, fuel pumps 28, 30 of APS 14, fuel pump 32 of MPCS 18, and a fuel pump (not depicted symbolically) of afterburner sub-system 22. Gearbox 12 also drives one or more electrical generators which provide electrical power to various electrically powered devices of fueldraulic system 10. Although MCPS 18, APS 14, and afterburner sub-system 22 are intercoupled with one another, each has a primary purpose. The primary purposes of MPCS 18 are to provide fueldraulic power to GG 20 (e.g., the combustion chamber) of the gas turbine engines. The primary purpose of APS 14 is to provide fueldraulic power to various fueldraulic actuators of actuation systems 16. The primary purpose of afterburner sub-system 22 is to provide fueldraulic power to manifold and spray bars 26 of the afterburner.

Each of MCPS 18, APS 14, and afterburner sub-system 22 will now be described in detail, beginning here with APS 14. In the depicted embodiment, APS 14 includes fuel inlet 38, boost pump 28, first variable-displacement pump (VDP) 30, main filter 34, and wash screen 36. Fuel from a fuel source is received (e.g., at pressure PF0) via fuel inlet 38 into APS 14. Boost pump 28 pumps the fuel received, via fuel inlet 38, to first supply line 40, thereby boosting fuel pressure in first supply line 40 from an inlet pressure PF0 to a first-supply-line pressure PF7. First supply line 40 is coupled to actuation systems 16 and functions as a relatively low-pressure supply of hydraulic fluid for actuation systems 16. The fuel also flows from first supply line 40 through main filter 34 to fuel oil cooler (FOC) 42 and to first VDP 30. First VDP 30 pumps the fuel pumped thereto, via boost pump 28, through wash screen 36 to second supply line 44, thereby boosting fuel pressure in second supply line 44 to a second-supply-line pressure PFH. Second supply line 44 is coupled to actuation systems 16 and functions as a relatively high-pressure supply of hydraulic fluid for actuation systems 16. First and second supply lines 40 and 44 provide the fueldraulic operation power for the various engine actuators included in actuation systems 16. Fuel at such pressure PFH of second supply line 44 is also provided to afterburner sub-system 22, for reasons that will be explained below.

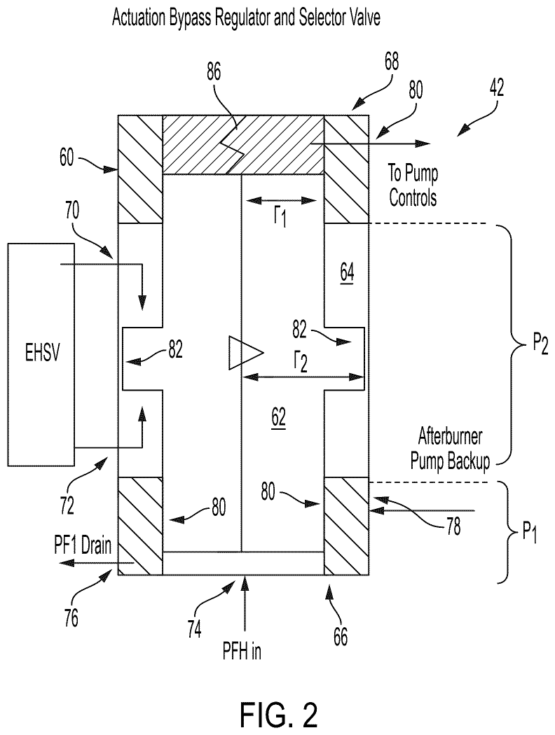

Afterburner sub-system 22 includes the afterburner pump, actuation bypass regulator and selector valve (ABRSV) 46, and electrohydraulic servo valve (EHSV) 48. Although not depicted, the afterburner pump can be configured to receive fuel from first supply line 40. The afterburner pump is configured to pump the fuel received to third supply 50, thereby boosting fuel pressure in third supply 50 to a third-supply-line pressure PFAFC. Third supply line 50 is coupled to afterburner control 24 where it can be used both for controlling actuators therein and for providing fuel, via manifold and spray bars 26, for combustion in the afterburners. ABSRV 46 is in fluid communication with each of first, second, and third supply lines 40, 44, and 50. ABSRV 46 is operably controlled via EHSV 48. ABSRV 46 is configured to perform multiple functions, as will be explained below with reference to FIG. 2.

MCPS 18 includes second VDP 32, which pumps fuel cooled by FOC 42, and pumps such cooled fuel through coarse and wash screens component 52 to windmill bypass valve (WMBV) 54 and metering valve (MV) 56. WMBV provides bypass regulation of the output pressure of fuel pumped by second VDP 32. MV meters the flow of fuel to GG 20. A main pump shut off valve (MPSOV) 58 downstream of the MV 56 may be configured to stop flow out of the MPCS 18 for shutoff.

FIG. 2 is a schematic view of an embodiment of an actuation bypass regulator and selector valve (ABRSV). In FIG. 2, ABRSV 46 includes hydraulic cylinder 60 and bilaterally moveable spool 62. Hydraulic cylinder 60 has cylindrical wall 64 extending between first and second ends 66 and 68. Cylindrical wall 64 has a first radius r₁ over a first portion P₁ and a second radius r₂ larger than the first radius r₁ over a second portion P₂, the cylindrical wall having a plurality of hydraulic ports therethrough including a pair of spool-controller ports 70 and 72 in the second portion P₂, and an actuator-supply port 74, a drain port 76, and an afterburner-supply port 78 in the first portion P₁. Bilaterally moveable spool 62 is axially moveable between first and second positions within hydraulic cylinder 60. Bilaterally moveable spool 62 has first sealing land 82 with a first radius configured to provide a hydraulic seal with an interior surface of cylindrical wall 64 within the first portion P₁. Bilaterally moveable spool 62 has second sealing land 84 configured to provide a hydraulic seal with an interior surface of cylindrical wall 64 within the second portion P₂.

Bilaterally moveable spool 62 is configured to provide fluid conductivity between actuator-supply port 74 and drain port 76 in response to a pressure differential between the pair of spool-controller ports 70 and 72 exceeding a first threshold pressure. Bilaterally moveable spool 62 is configured to provide fluid conductivity between actuator-supply port 74 and afterburner-supply port 78 in response to a pressure differential between the pair of spool-controller ports 70 and 72 exceeding a second threshold pressure, which is greater than the first supply pressure. In response to the pressure differential between the pair of spool-controller ports 70 and 72 exceeding a first threshold pressure, bilaterally moveable spool 62 is moved from the first position at first end 66 of hydraulic cylinder 60. As bilaterally moveable spool 62 moves away from first end 66 of hydraulic cylinder 60, drain port 76 is exposed, thereby putting drain port 76 in fluid communication with actuator-supply port 74. When in such fluid communication, some of the fuel in second supply line 44 is conducted to first supply line 40. As bilaterally moveable spool 62 moves further away from first end 66 of hydraulic cylinder 60, afterburner-supply port 78 is exposed, thereby putting afterburner-supply port 78 in fluid communication with actuator-supply port 74. When in such fluid communication, fuel in third supply line 50 is conducted to first supply line 40. In this manner the afterburner fuel pump is providing fueldraulic power to actuator systems 16, thereby operating as a backup fueldraulic pump for first VDP 30.

Bilaterally moveable spool 62 is in the first position when the bilaterally moveable spool is moved to the first end of the hydraulic cylinder, and the bilaterally moveable spool is in the second position when the bilaterally moveable spool is moved to the second end of the hydraulic cylinder. In some embodiments, spring 86 is configured to provide a spring force directing bilaterally moveable spool 62 toward the first position. In the depicted embodiments, actuator-supply port 74 is at first end 66 of hydraulic cylinder 60. In the depicted embodiment, drain port 76 and afterburner-supply port 78 are sequentially exposed by hydraulic seal 82 of the first portion P₁ as bilaterally moveable spool 62 is moved away from first end 66 of hydraulic cylinder 60 in response to increasing pressure differential of hydraulic fluid between the pair of spool-controller ports 70 and 72. ABSRV 46 can provide bypass regulation of fluid pressure at actuator-supply port 74 by providing variable fluid conductivity between the actuator-supply port and the drain port. In some embodiments, cylindrical wall 64 of hydraulic cylinder 60 can have pump-control port 86 at second end 68 of hydraulic cylinder 60. In such embodiments, bilaterally moveable spool 62 can provide fluid conductivity between actuator-supply port 74 and pump-control port 86 via longitudinal lumen 88 therethrough.

In some embodiments ABSRV 46 can include a position measurement system, such as for example a linear variable differential transformer. Such a linear variable differential transformer could be located at second end 68 of ABSRV 46, thereby having an electromagnetic coupling change between primary and secondary windings in response to the amount of bilaterally moveable spool is present proximate or within windings of the linear variable differential transformer. Such a position measurement system can sense position of bilaterally moveable spool 62 within hydraulic cylinder 60. The position measurement system can then send a signal indicative of the position to an engine controller. The engine controller can then perform closed-loop control of ABRSV 46, thereby metering bypass flow rates. In this way, bypass flow rates can be controlled based on both position of bilaterally moveable spool 62 and fluid pressure at actuator-supply port 74. The position sensor can also indicate whether ABRSV 46 is fully opened, providing backup pumping to actuation systems 16.

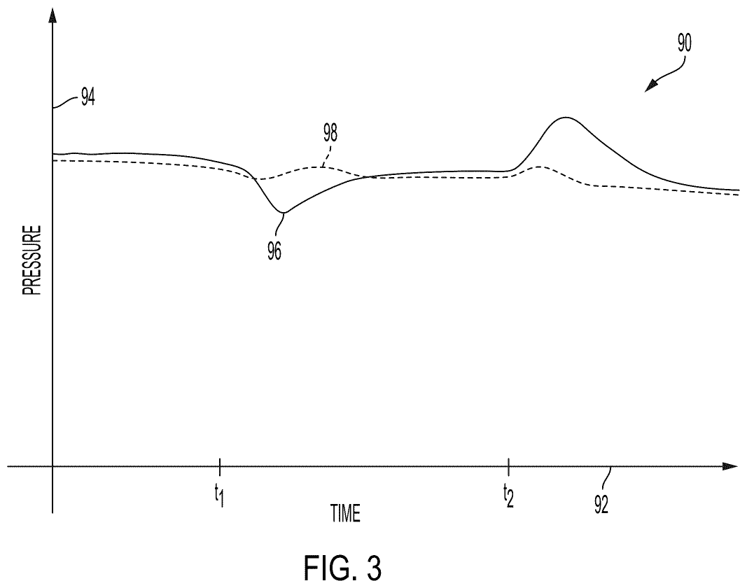

FIG. 3 is a graph of a pressure/time relation for a fueldraulic system having an ABRSV to regulate bypass of an actuation system. In FIG. 3, graph 90 includes horizontal axis 92, vertical axis 94, first pressure-time relation 96 and second pressure-time relation 98. Horizontal axis 92 is indicative of time and vertical axis 94 is indicative of pressure at second supply line 44 (depicted in FIG. 1). First pressure-time relation 96 depicts the pressure of second supply line 44, when bypass regulation is not performed by a valve such as ABRSV 46. At time t₁, an engine actuator is moved, which causes an increase in demand of fuel through second supply line 44. Because of the increased demand for fuel, pressure within second supply line 44 dips temporarily. Then at time t₂, the engine actuator stops its movement, which causes a decrease in demand of fuel through second supply line 44. Because of the decreased demand for fuel, pressure within second supply line 44 peaks temporarily. Second pressure-time relation 98 depicts the pressure of second supply line 44, when bypass regulation is performed by a valve such as ABRSV 46. At both times t₁ and t₂ little disturbance of pressure is shown. At time t₁, when the engine actuator is moved and the demand of fuel through second supply line 44 increases, ABRSV 46 stops bypassing fuel which provides for the increased demand for fuel. Then, at time t₂, when the engine actuator stops its movement and the demand of fuel through second supply line 44 decreases, ABRSV 46 resumes bypassing fuel which provides for the decreased demand for fuel.

### DISCUSSION OF POSSIBLE EMBODIMENTS

The following are non-exclusive descriptions of possible embodiments of the present invention.

Some embodiments relate to a fueldraulic valve for a gas turbine engine configured to regulate actuation pressure and to select between an actuation pump and a backup pump. The fueldraulic valve includes a hydraulic cylinder and a bilaterally moveable spool. The hydraulic cylinder has a cylindrical wall extending between first and second ends. The cylindrical wall has a first radius over a first portion and a second radius larger than the first radius over a second portion. The cylindrical wall has a plurality of hydraulic ports therethrough including a pair of spool-controller ports in the second portion, and an actuator-supply port, a drain port, and an afterburner-supply port in the first portion. The bilaterally moveable spool is axially moveable between first and second positions within the hydraulic cylinder. The bilaterally moveable spool has a first sealing land with a first radius configured to provide a hydraulic seal with an interior surface of the cylindrical wall within the first portion and a second sealing land configured to provide a hydraulic seal with an interior surface of the cylindrical wall within the second portion. The bilaterally moveable spool is configured to provide fluid conductivity between the actuator-supply port and the drain port in response to a pressure differential between the pair of spool-controller ports exceeding a first threshold pressure. The bilaterally moveable spool is configured to provide fluid conductivity between the actuator-supply port and the afterburner-supply port in response to a pressure differential between the pair of spool-controller ports exceeding a second threshold pressure, which is greater than a first supply pressure.

The fueldraulic valve of the preceding paragraph can optionally include, additionally and/or alternatively, any one or more of the following features, configurations and/or additional components:

A further embodiment of the foregoing fueldraulic valve, wherein the bilaterally moveable spool can be in the first position when the bilaterally moveable spool is at the first end of the hydraulic cylinder, and the bilaterally moveable spool can be in the second position when the bilaterally moveable spool is at the second end of the hydraulic cylinder

A further embodiment of any of the foregoing fueldraulic valves can further include a spring configured to provide a spring force directing the bilaterally moveable spool toward the first position.

A further embodiment of any of the foregoing fueldraulic valves, wherein the actuator-supply port can be at the first end of the hydraulic cylinder.

A further embodiment of any of the foregoing fueldraulic valves, wherein the drain port and the afterburner-supply port can be sequentially exposed by the hydraulic seal of the first portion as the bilaterally moveable spool is moved away from the first end of the hydraulic cylinder in response to increasing pressure differential of hydraulic fluid between the pair of spool-controller ports.

A further embodiment of any of the foregoing fueldraulic valves, wherein the fueldraulic valve can be configured to provide bypass regulation of fluid pressure at the actuator-supply port by providing variable fluid conductivity between the actuator-supply port and the drain port.

A further embodiment of any of the foregoing fueldraulic valves, wherein the cylindrical wall of the hydraulic cylinder can further have a pump-control port at the second end of the hydraulic cylinder.

A further embodiment of any of the foregoing fueldraulic valves, wherein the bilaterally moveable spool can have a longitudinal lumen therethrough, thereby providing fluid conductivity between the actuator-supply port and the pump-control port.

Some embodiments relate to a fueldraulic system for a gas turbine engine. The fueldraulic system includes a variable-displacement fueldraulic actuator pump configured to provide fueldraulic actuator power to an actuator of the gas turbine engine. The fueldraulic system includes an afterburner fuel pump configured provide fueldraulic afterburner power thereby supplying fuel to an afterburner of the gas turbine engine. The fueldraulic system includes a fueldraulic valve configured to provide bypass regulation of the fueldraulic power and to shunt the fueldraulic afterburner power to the fueldraulic actuator power in response to a failure of the variable-displacement fueldraulic actuator pump. The fueldraulic valve includes a hydraulic cylinder and a bilaterally moveable spool. The hydraulic cylinder has a cylindrical wall extending between first and second ends. The cylindrical wall has a first radius over a first portion and a second radius larger than the first radius over a second portion. The cylindrical wall has a plurality of hydraulic ports therethrough including a pair of spool-controller ports in the second portion, and an actuator-supply port in fluid communication with the variable-displacement fueldraulic actuator pump, a drain port, and an afterburner-supply port in fluid communication with the afterburner fuel pump in the first portion. The bilaterally moveable spool is axially moveable between first and second positions within the hydraulic cylinder. The bilaterally moveable spool has a first sealing land with a first radius configured to provide a hydraulic seal with an interior surface of the cylindrical wall within the first portion and a second sealing land configured to provide a hydraulic seal with an interior surface of the cylindrical wall within the second portion. The bilaterally moveable spool is configured to provide fluid conductivity between the actuator-supply port and the drain port in response to a pressure differential between the pair of spool-controller ports exceeding a first threshold pressure. The bilaterally moveable spool is configured to provide fluid conductivity between the actuator-supply port and the afterburner-supply port in response to a pressure differential between the pair of spool-controller ports exceeding a second threshold pressure, which is greater than a first supply pressure.

The fueldraulic system of the preceding paragraph can optionally include, additionally and/or alternatively, any one or more of the following features, configurations and/or additional components:

A further embodiment of any of the foregoing fueldraulic systems can further include a fueldraulic controller configured to control fueldraulic power provided to the pair of spool-controller ports, thereby controlling positioning of the bilaterally moveable spool within the hydraulic cylinder.

A further embodiment of any of the foregoing fueldraulic systems can further include a pressure sensor configured to sense pressure output from the variable-displacement fueldraulic actuator pump.

A further embodiment of any of the foregoing fueldraulic systems, wherein the fueldraulic controller can further be configured to cause the bilaterally moveable spool to move from the first position so as to expose the drain port of the cylindrical wall in response to pressure output from the variable-displacement fueldraulic actuator pump falling below a threshold pressure. When exposed, the drain port can be in fluid communication with the actuator-supply port.

A further embodiment of any of the foregoing fueldraulic systems, wherein the fueldraulic controller can further be configured to cause the bilaterally moveable spool to move from the first position so as to expose the afterburner-supply port of the cylindrical wall in response to pressure output from the variable-displacement fueldraulic actuator pump falling below a threshold pressure. When exposed, the afterburner-supply port can be in fluid communication with the actuator-supply port.

A further embodiment of any of the foregoing fueldraulic systems, wherein the bilaterally moveable spool can be in the first position when the bilaterally moveable spool is at the first end of the hydraulic cylinder, and the bilaterally moveable spool can be in the second position when the bilaterally moveable spool is at the second end of the hydraulic cylinder

A further embodiment of any of the foregoing fueldraulic systems can further include a spring configured to provide a spring force directing the bilaterally moveable spool toward the first position.

A further embodiment of any of the foregoing fueldraulic systems, wherein the actuator-supply port can be at the first end of the hydraulic cylinder.

A further embodiment of any of the foregoing fueldraulic systems, wherein the drain port and the afterburner-supply port can be sequentially exposed by the hydraulic seal of the first portion as the bilaterally moveable spool is moved away from the first end of the hydraulic cylinder in response to increasing pressure differential of hydraulic fluid between the pair of spool-controller ports.

A further embodiment of any of the foregoing fueldraulic systems, wherein the fueldraulic valve can be configured to provide bypass regulation of fluid pressure at the actuator-supply port by providing variable fluid conductivity between the actuator-supply port and the drain port.

A further embodiment of any of the foregoing fueldraulic systems, wherein the cylindrical wall of the hydraulic cylinder can further have a pump-control port at the second end of the hydraulic cylinder.

A further embodiment of any of the foregoing fueldraulic systems, wherein the bilaterally moveable spool can have a longitudinal lumen therethrough, thereby providing fluid conductivity between the actuator-supply port and the pump-control port.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fueldraulic valve for a gas turbine engine configured to regulate actuation pressure and to select between an actuation pump and a backup pump, the fueldraulic valve comprising:
a hydraulic cylinder having a cylindrical wall extending between first and second ends; the cylindrical wall having a first radius over a first portion and a second radius larger than the first radius over a second portion, the cylindrical wall having a plurality of hydraulic ports therethrough including a pair of spool-controller ports in the second portion, and an actuator-supply port, a drain port, and an afterburner-supply port in the first portion; and
a bilaterally moveable spool axially moveable between first and second positions within the hydraulic cylinder, the bilaterally moveable spool having a first sealing land with a first radius configured to provide a hydraulic seal with an interior surface of the cylindrical wall within the first portion and a second sealing land configured to provide a hydraulic seal with an interior surface of the cylindrical wall within the second portion,
wherein:
the bilaterally moveable spool is configured to provide fluid conductivity between the actuator-supply port and the drain port in response to a pressure differential between the pair of spool-controller ports exceeding a first threshold pressure, and
the bilaterally moveable spool is configured to provide fluid conductivity between the actuator-supply port and the afterburner-supply port in response to a pressure differential between the pair of spool-controller ports exceeding a second threshold pressure, which is greater than a first supply pressure.

2. The fueldraulic valve of claim 1, wherein the bilaterally moveable spool is in the first position when the bilaterally moveable spool is at the first end of the hydraulic cylinder, and the bilaterally moveable spool is in the second position when the bilaterally moveable spool is at the second end of the hydraulic cylinder.

3. The fueldraulic valve of claim 2, further comprising a spring configured to provide a spring force directing the bilaterally moveable spool toward the first position.

4. The fueldraulic valve of claim 3, wherein the actuator-supply port is at the first end of the hydraulic cylinder.

5. The fueldraulic valve of claim 4, wherein the drain port and the afterburner-supply port are sequentially exposed by the hydraulic seal of the first portion as the bilaterally moveable spool is moved away from the first end of the hydraulic cylinder in response to increasing pressure differential of hydraulic fluid between the pair of spool-controller ports.

6. The fueldraulic valve of claim 5, wherein the fueldraulic valve is configured to provide bypass regulation of fluid pressure at the actuator-supply port by providing variable fluid conductivity between the actuator-supply port and the drain port.

7. The fueldraulic valve of claim 3, wherein the cylindrical wall of the hydraulic cylinder further has a pump-control port at the second end of the hydraulic cylinder.

8. The fueldraulic valve of claim 7, wherein the bilaterally moveable spool has a longitudinal lumen therethrough, thereby providing fluid conductivity between the actuator-supply port and the pump-control port.

9. A fueldraulic system for a gas turbine engine, the fueldraulic system comprising:
a variable-displacement fueldraulic actuator pump configured to provide fueldraulic actuator power to an actuator of the gas turbine engine;
an afterburner fuel pump configured to provide fueldraulic afterburner power thereby supplying fuel to an afterburner of the gas turbine engine; and
a fueldraulic valve configured to provide bypass regulation of the fueldraulic power and to shunt the fueldraulic afterburner power to the fueldraulic actuator power in response to a failure of the variable-displacement fueldraulic actuator pump,
wherein the fueldraulic valve includes:
a hydraulic cylinder having a cylindrical wall extending between first and second ends; the cylindrical wall having a first radius over a first portion and a second radius larger than the first radius over a second portion, the cylindrical wall having a plurality of hydraulic ports therethrough including a pair of spool-controller ports in the second portion, and an actuator-supply port in fluid communication with the variable-displacement fueldraulic actuator pump, a drain port, and an afterburner-supply port in fluid communication with the afterburner fuel pump in the first portion; and
a bilaterally moveable spool axially moveable between first and second positions within the hydraulic cylinder, the bilaterally moveable spool having a first sealing land with a first radius configured to provide a hydraulic seal with an interior surface of the cylindrical wall within the first portion and a second sealing land configured to provide a hydraulic seal with an interior surface of the cylindrical wall within the second portion,
wherein:
the bilaterally moveable spool is configured to provide fluid conductivity between the actuator-supply port and the drain port in response to a pressure differential between the pair of spool-controller ports exceeding a first threshold pressure, and
the bilaterally moveable spool is configured to provide fluid conductivity between the actuator-supply port and the afterburner-supply port in response to a pressure differential between the pair of spool-controller ports exceeding a second threshold pressure, which is greater than a first supply pressure.

10. The fueldraulic system of claim 9, further comprising:
a fueldraulic controller configured to control fueldraulic power provided to the pair of spool-controller ports, thereby controlling positioning of the bilaterally moveable spool within the hydraulic cylinder.

11. The fueldraulic system of claim 10, further comprising:
a pressure sensor configured to sense pressure output from the variable-displacement fueldraulic actuator pump.

12. The fueldraulic system of claim 10, wherein the fueldraulic controller is further configured to:
cause the bilaterally moveable spool to move from the first position so as to expose the drain port of the cylindrical wall in response to pressure output from the variable-displacement fueldraulic actuator pump falling below a threshold pressure, wherein, when exposed, the drain port is in fluid communication with the actuator-supply port.

13. The fueldraulic system of claim 10, wherein the fueldraulic controller is further configured to:
cause the bilaterally moveable spool to move from the first position so as to expose the afterburner-supply port of the cylindrical wall in response to pressure output from the variable-displacement fueldraulic actuator pump falling below a threshold pressure wherein, when exposed, the afterburner-supply port is in fluid communication with the actuator-supply port.

14. The fueldraulic system of claim 9, wherein the bilaterally moveable spool is in the first position when the bilaterally moveable spool is at the first end of the hydraulic cylinder, and the bilaterally moveable spool is in the second position when the bilaterally moveable spool is at the second end of the hydraulic cylinder.

15. The fueldraulic system of claim 14, further comprising a spring configured to provide a spring force directing the bilaterally moveable spool toward the first position.

16. The fueldraulic system of claim 15, wherein the actuator-supply port is at the first end of the hydraulic cylinder.

17. The fueldraulic system of claim 16, wherein the drain port and the afterburner-supply port are sequentially exposed by the hydraulic seal of the first portion as the bilaterally moveable spool is moved away from the first end of the hydraulic cylinder in response to increasing pressure differential of hydraulic fluid between the pair of spool-controller ports.

18. The fueldraulic system of claim 17, wherein the fueldraulic valve is configured to provide bypass regulation of fluid pressure at the actuator-supply port by providing variable fluid conductivity between the actuator-supply port and the drain port.

19. The fueldraulic system of claim 15, wherein the cylindrical wall of the hydraulic cylinder further has a pump-control port at the second end of the hydraulic cylinder.

20. The fueldraulic system of claim 19, wherein the bilaterally moveable spool has a longitudinal lumen therethrough, thereby providing fluid conductivity between the actuator-supply port and the pump-control port.
